(19) United States
(12) Patent Application Publication
(10) Pub. No.: US 2003/0126952 A1
(43) Pub. Date: Jul. 10, 2003

(54) Method of producing chainsaw chain allowing to increase the effectiveness of the woodcutter in modifying the cutter links and some safety links

(76) Inventor: Germain Duquet, Sillery (CA)

Correspondence Address: MR. GERMAIN DUQUET, Suite 405, 2580 Rue DU PLAZA, Sillery, QC, GIT 1X1, CA

(21) Appl. No.: 10/036,892

(22) Filed: Jan. 4, 2002

(51) Int. Cl. B27B 33/14

(52) U.S. Cl. 76/112; 83/834

(57) ABSTRACT

The present invention is a method of producing chainsaw chain allowing to increase the effectiveness of the woodcutter in modifying the cutter links and some safety links.

Method of producing chainsaw chain allowing to increase the effectiveness of the woodcutter in modifying the cutter links and some safety links.

### BACKGROUND OF THE INVENTION

1. Field of the Invention

The present invention relates to a method of producing chainsaw chain allowing to increase the effectiveness of the woodcutter in modifying the cutter links and some safety links.

2. Description of the Related Art

A search of prior art records has unveiled the following patents:

1. No CA 1,195,211 issued in 1985 to Landwehr;

2. No CA 627238 issued in 1961 to August;

3. No CA 651448 issued in 1962 to August;

4. No U.S. Pat. No. 4,088,047 issued in 1978 to Ratz and al.;

5. No U.S. Pat. No. 4,567,803 issued in 1986 to Anderson;

6. No U.S. Pat. No. 4,756,221 issued in 1988 to Nitschmann and al.; and

7. No U.S. Pat. No. 4,414,876 issued in 1983 to Loigerot.

The patent to Ratz is probably the most relevant. As can be seen, the patent to Ratz shows a method of producing cutting teeth for a chain saw each of which has a base body and a tooth roof, and in which the base body is cranked along a substantially sharp edge relative to tooth roof.

Different chainsaw chains are effective only that when the user pulls down the safety links to increase the speed of the woodcutter, whereas the present invention allows to the chain to cut more rapidly and to be less drawn, and to make safely a deep and narrow woodcutter in modifying the cutter links and some safety links.

None the chainsaw chains sold at present on the market resolve with effectiveness and simplicity the whole of the problems which usually occur during the woodcutter.

### SUMMARY OF THE INVENTION

The gist of the invention is therefore to produce a chainsaw chain allowing to increase the effectiveness of the woodcutter in modifying the cutter links and some safety links.

The present invention allows to the chain to cut more rapidly and to be less drawn, and to make safely a deep and narrow woodcutter in modifying the cutter links and some safety links.

### ADVANTAGES OF THE INVENTION

Maintenance less;

More safe;

Increase the chain, chainsaw and guide bar durability;

Increase the sharpening durability;

Increase the woodcutter;

Diminution of the gasoline and oil consumption;

Diminution of the vibration and kickback;

Diminution of physique effort;

Diminution of chainsaw derailment; and

Diminution of the rejection of saw twig in the visor.

### BRIEF DESCRIPTION OF THE SEVERAL VIEWS OF THE DRAWING(S)

FIG. 1 shows a left side perspective view of the chain.

FIG. 2 shows a right side perspective view of the chain.

FIG. 3 shows an exploded view of the chain.

FIG. 4 shows a perspective left side view of cutter link.

FIG. 5 shows a perspective right side view of cutter link.

FIG. 6 shows a front view of cutter link.

FIG. 7 shows a perspective view of a safety link.

### DETAILED DESCRIPTION OF THE INVENTION

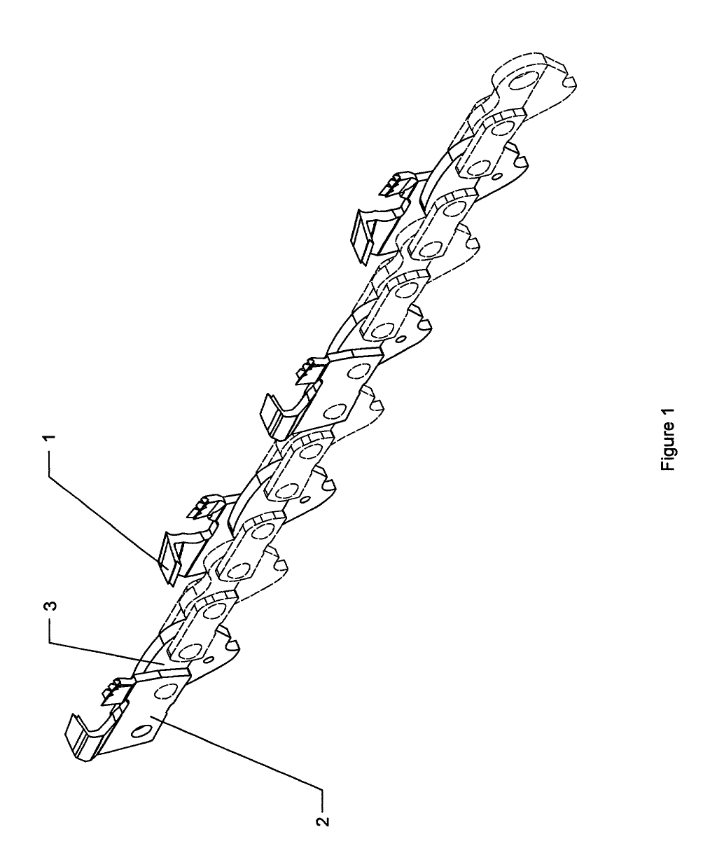

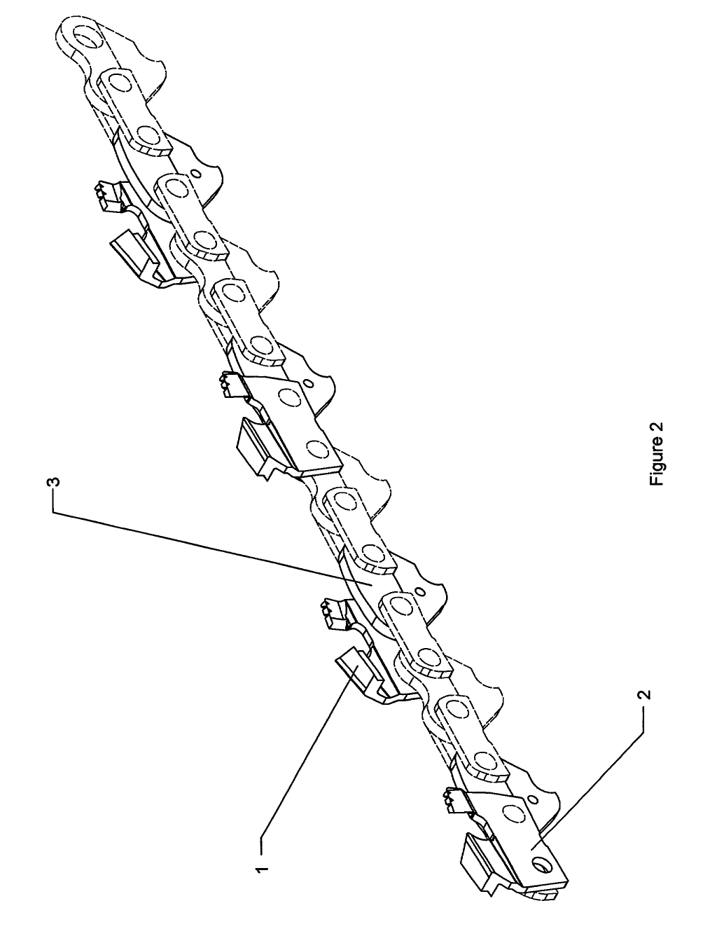

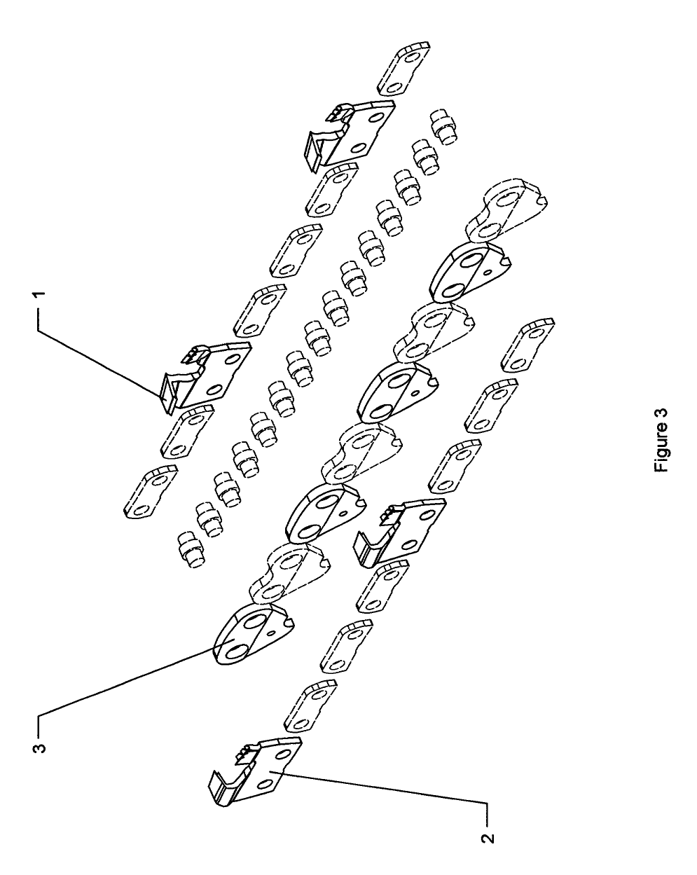

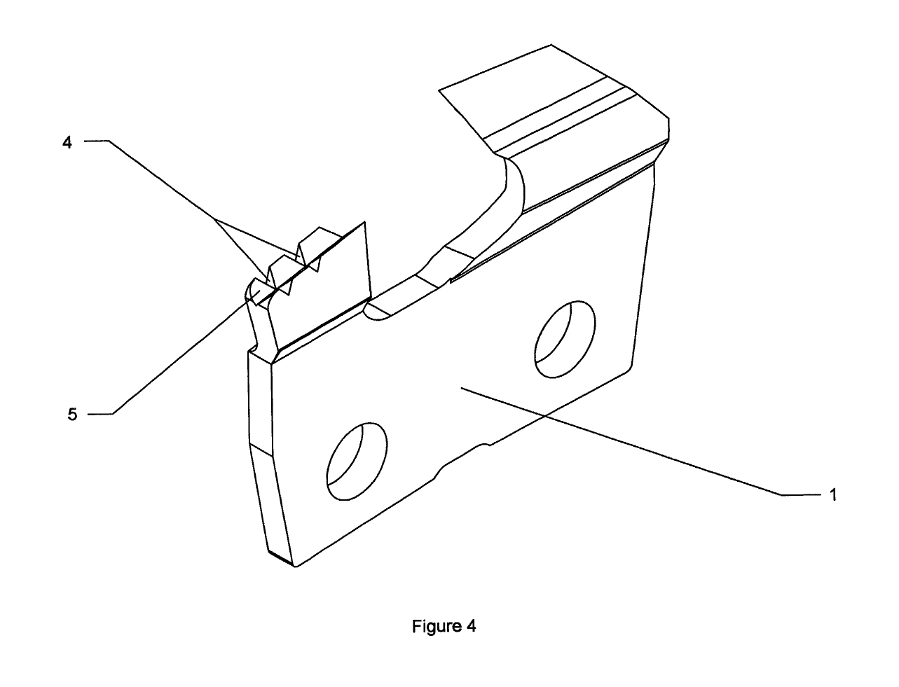

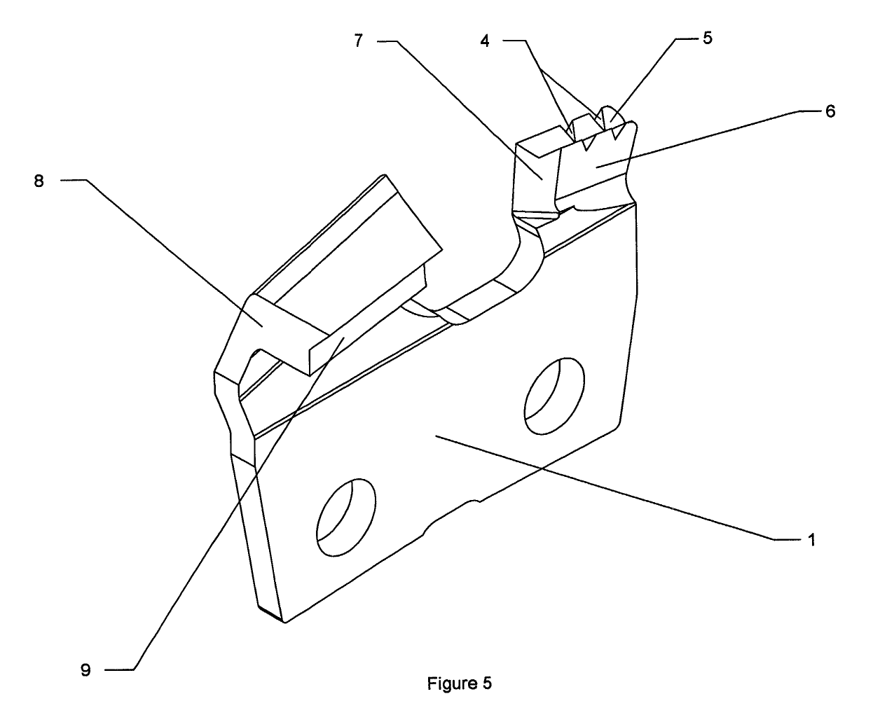

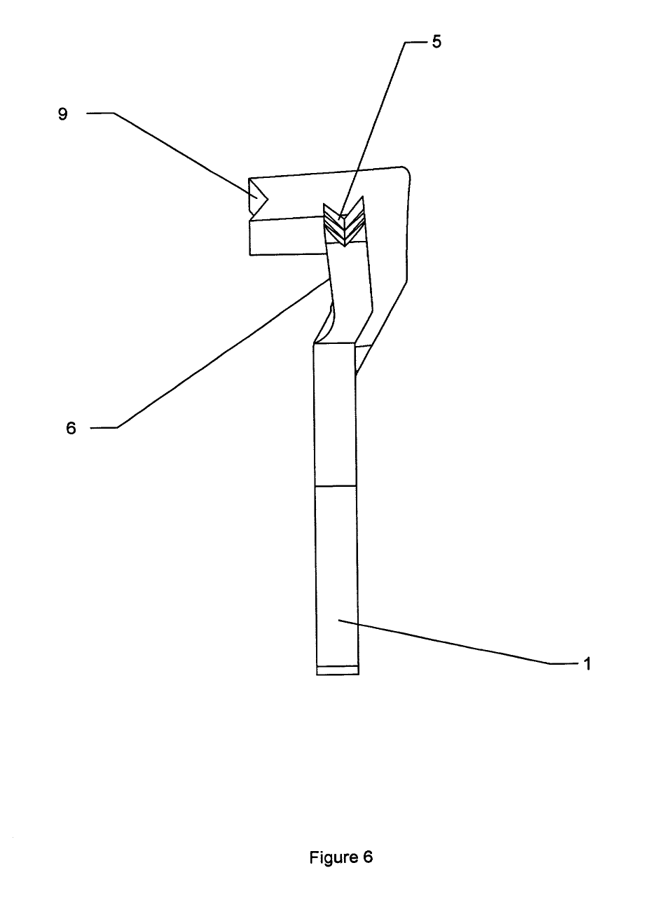

As illustrated in FIGS. 1, 2, 3, 4, 5 and 6, the method producing a chainsaw chain allows to increase the effectiveness of the woodcutter in modifying the cutter links (1,2) and some safety links (3).

The interior side of the superior part from the rockers has a longitudinal furrow (5) and the transversal grooves (4), allowing to cut more rapidly the tree branches, to decrease the vibration and require less of power-driven. The superior part of rockers is lightly inclined toward the thinning inward (6) of rockers, allowing to the cutter links (1,2) to be less drawn toward the outside, and even so to decrease the vibration, the kickback, the friction of the chain onto the guide bar and increase the speed of the woodcutter. The fact to level the top of rockers in keeping the front and back inclination, to have a longitudinal furrow (5) and to put at angle the back side in relation to the lateral side, allows to make a more deep and narrow woodcutter. The bevelled lateral cutting edge (7) of rockers, the cutter links (1,2) having a lateral furrow (9), and the upper cutting edge (8) of cutter links (1,2) which is bevelled onto the back side of upper cutting edge (8), allow to increase the speed of the woodcutter.

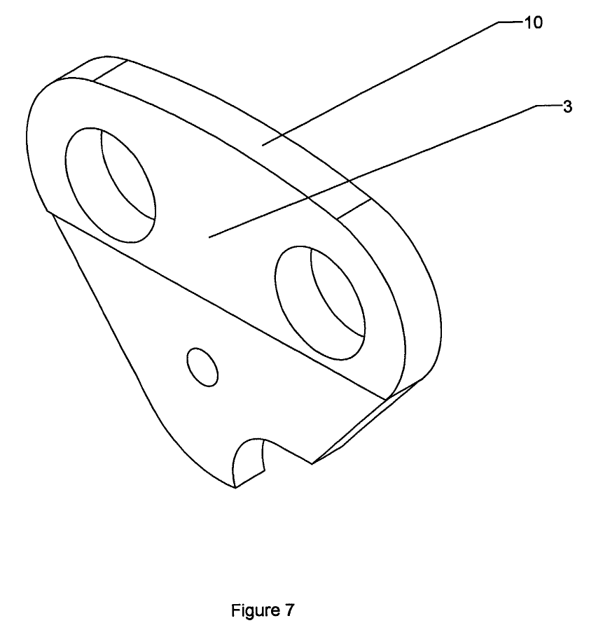

As illustrated in FIG. 7, the introduced modification to the superior part from each safety link (3) and the lowering (10) of the safety links does not increase the kickback, but improve greatly the speed of the woodcutter and stay safe.

Although only a single embodiment of the present invention has been described and illustrated, the present invention is not limited to the features of this embodiment, but includes all variations and modifications within the scope of claims.

Legend:

1: Left cutter link

2: Right cutter link

3: Safety links

4: Grooves in the rockers

5: Longitudinal furrow in the rockers

6: Thinning inward of rockers

7: Lateral cutting edge of rockers

8: Back upper cutting edge of the cutter links

9: Lateral furrow of the cutter links

10: Lowering of safety links

The embodiments of the invention for which an exclusive property or privilege is claimed, are defined as follows:

1. A method of producing chainsaw chain, which said method allows to increase the effectiveness of the woodcutter in modifying the cutter links and some safety links, which the interior side of the superior part from the rockers has a longitudinal furrow and the transversal grooves allowing to cut more rapidly the tree branches, to decrease the vibration and require less of power-driven; the superior part of said rockers is lightly inclined toward the thinning inward of said rockers allowing to said cutter links to be less drawn toward the outside, and even so to decrease the vibration, the kickback, the friction of the chain onto the guide bar and increase the speed of the woodcutter; and the fact to level the top of said rockers in keeping the front and back inclination, to have a longitudinal furrow and to put at angle the back side in relation to the lateral side, it allows to make a more deep and narrow woodcutter. The bevelled lateral cutting edge of said rockers, said cutter links having a lateral furrow and the upper cutting edge of said cutter links which is bevelled onto the back side of said upper cutting edge, allow to increase the speed of the woodcutter.

2. A method of producing chainsaw chain, as defined in claim 1, which the introduced modification to the superior part from each said safety link and the lowering of said safety links does not increase the kickback, but improve greatly the speed of the woodcutter; and which each said safety link is parted with a standard safety link.
